(19) United States
(12) Patent Application Publication
(10) Pub. No.: US 2014/0361999 A1
(43) Pub. Date: Dec. 11, 2014

(54) ELECTRONIC DEVICE AND METHOD FOR INSERTING COMMENTS USING THE ELECTRONIC DEVICE

(71) Applicant: FIH (Hong Kong) Limited, Kowloon (HK)

(72) Inventor: CHIH-WEI CHANG, New Taipei (TW)

(73) Assignee: FIH (Hong Kong) Limited, Kowloon (HK)

(21) Appl. No.: 14/014,305

(22) Filed: Aug. 29, 2013

(30) Foreign Application Priority Data
Jun. 6, 2013 (CN) 2013102215287

(51) Int. Cl. G06F 3/0488

(52) U.S. Cl. CPC G06F 3/0488
USPC 345/173

(57) ABSTRACT

A method for inserting comments is used in an electronic device. The electronic device includes a touch panel having a corner formed by two adjacent edges. A content region and a comment region are divided of an electronic document respectively in response to a dividing operation on the touch panel. The comments edited in the commend region are received by the electronic device. The comment is linked with content of the document in response to a linking operation. The dividing operation is implemented by drawing a broken line perpendicularly connecting to the edges to form a corner region and folding the corner region to form the comment region.

### BACKGROUND

1. Technical Field

The disclosure generally relates to comment inserting technology; and particularly to an electronic device and method for inserting comments using the electronic device.

2. Description of the Related Art

Many electronic devices, such as mobile phones and personal computers, have touch-sensitive screens that can be used to display electronic documents. The electronic devices commonly have a comment inserting function where a fixed comment column on the bottom of the document is used to edit comments. However, when the document has many pages, the pages having comments cannot be easily nor quickly searched.

Therefore, there is room for improvement within the art.

### BRIEF DESCRIPTION OF THE DRAWINGS

Many aspects of an exemplary electronic device and method for inserting comments using the electronic device can be better understood with reference to the following drawings. The components in the drawings are not necessarily drawn to scale, the emphasis instead being placed upon clearly illustrating the principles of the present embodiments.

FIG. 1 is a block diagram of one embodiment of an electronic device including a comment inserting system.

FIG. 2 is a schematic diagram of one embodiment of a dividing operation on a touch panel of the electronic device of FIG. 1.

FIG. 3 is a schematic diagram of one embodiment of a linking operation on the touch panel of the electronic device of FIG. 1.

FIG. 4 is an enlarged view of the circled portion IV of FIG. 3.

FIG. 5 is a schematic diagram of one embodiment of a hiding operation on the touch panel of the electronic device of FIG. 1.

FIG. 6 is an enlarged view of the circled portion VI of FIG. 5.

FIG. 7 is a flowchart of one embodiment of a comment inserting method using the comment inserting system of FIG. 1.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

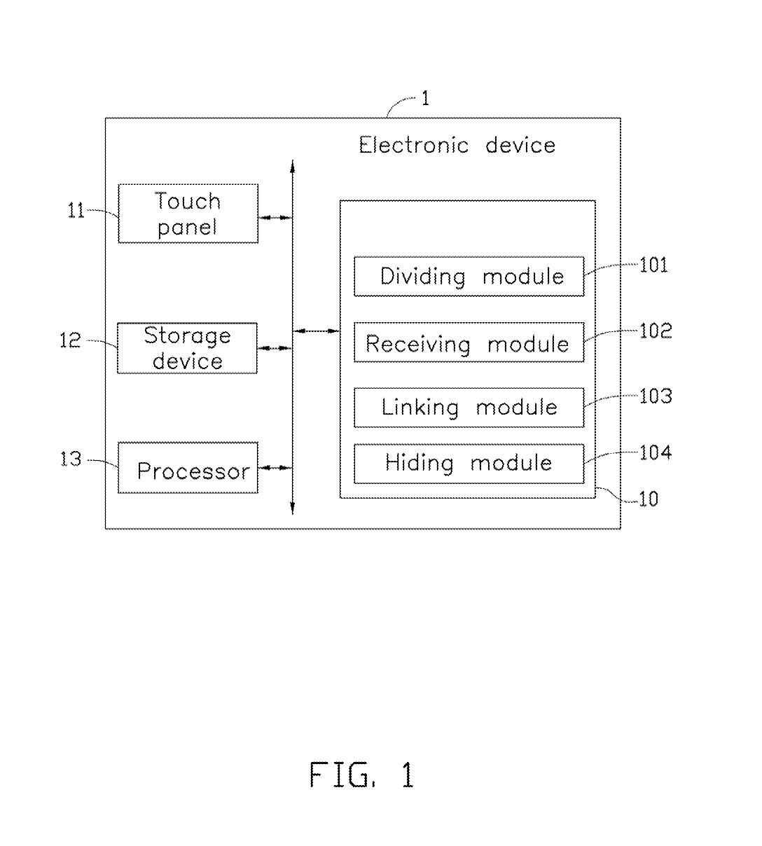

FIG. 1 is a block diagram of one embodiment of an electronic device 1. The electronic device 1 includes a comment inserting system 10. The electronic device 1 may be a cell phone, a personal digital assistant, a tablet computer, or any other computing device. The electronic device 1 further includes a touch panel 11. The touch panel 11 is used to input and output relevant data, such as images and files, for example. In some embodiments, the touch panel 11 may be a capacitive touch panel or a resistive touch panel that offers multi-touch capability.

The electronic device 1 further includes a storage device 12 providing one or more memory functions, and at least one processor 13. In one embodiment, the comment inserting system 10 may include computerized instructions in the form of one or more programs, which are stored in the storage device 12 and executed by the processor 12 to perform operations of the electronic device 1.

The storage device 12 stores one or more programs, such as programs of the operating system, other applications of the electronic device 1, and various kinds of documents, such as text documents. In some embodiments, the storage device 12 may include a memory of the electronic device 1 and/or an external storage card, such as a memory stick, a smart media card, a compact flash card, or any other type of memory card. FIG. 1 illustrates only one example of the electronic device 1 that may include more or fewer components than as illustrated, or have a different configuration of the various components.

In one embodiment, the comment inserting system 10 may include one or more modules, for example, a dividing module 101, a receiving module 102, a linking module 103, and a hiding module 104. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

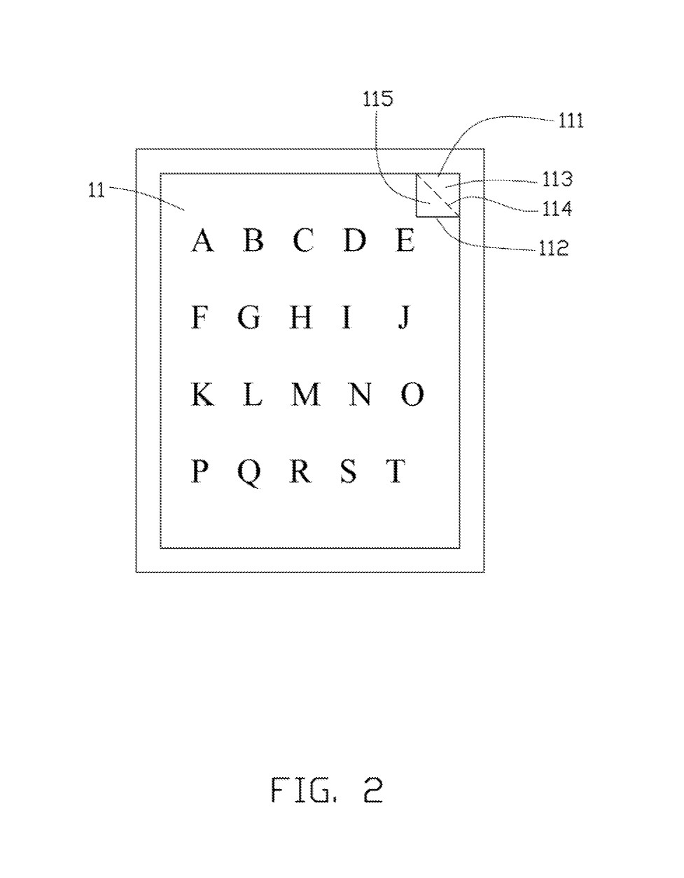

The dividing module 101 divides a content region and a comment region of an electronic document respectively displaying content and comments of the document in response to a dividing operation performed on the touch panel 11. FIG. 2 shows that the touch panel 11 is substantially rectangular and includes a corner 111 formed by two adjacent edges of the touch panel 11. In the dividing operation, a user can draw a substantially L-shaped broken line 112 at the corner 111 by touching the touch screen 11 using his finger or a touch stylus. Two ends of the broken line 112 are perpendicularly connected to the two edges of corner 111 and form a corner region 113 with the corner 111. A region of the touch panel 11 excepting the corner region 113 is defined as the content region. The corner region 13 is folded along a diagonal line 114 of the corner region 113 to form a substantially triangular comment region 115. Therefore, the comment region 115 can be used to insert the comments by simulating a folding operation of a page of a conventional book.

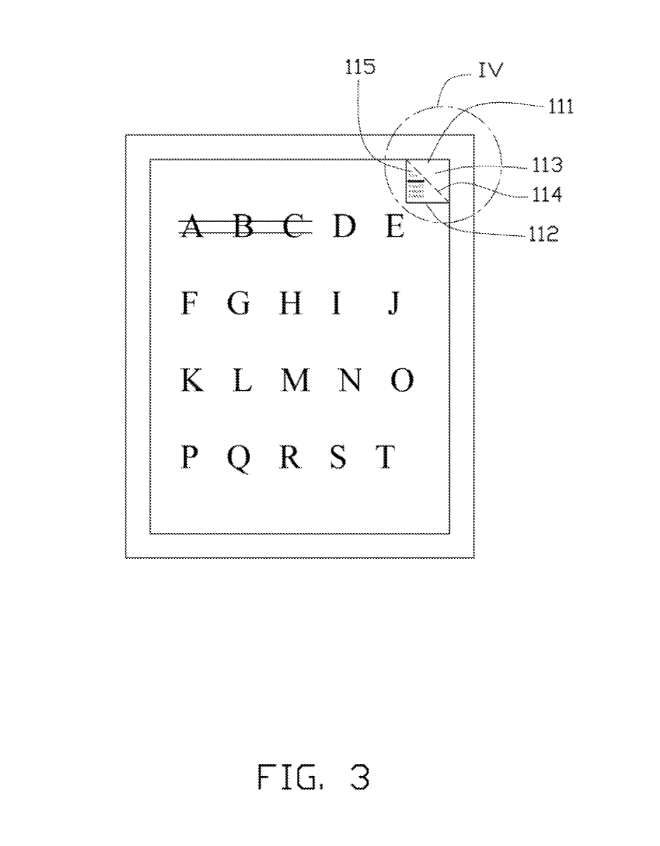

The receiving module 102 receives the comments edited in the comment region 115 from an editing operation. FIG. 3 shows that in the editing operation, the user can perform a double click operation the comment region 115 by touching the touch screen using his finger or the touch stylus and then edits the comments in the comment region 15 by adding or deleting characters of the comments.

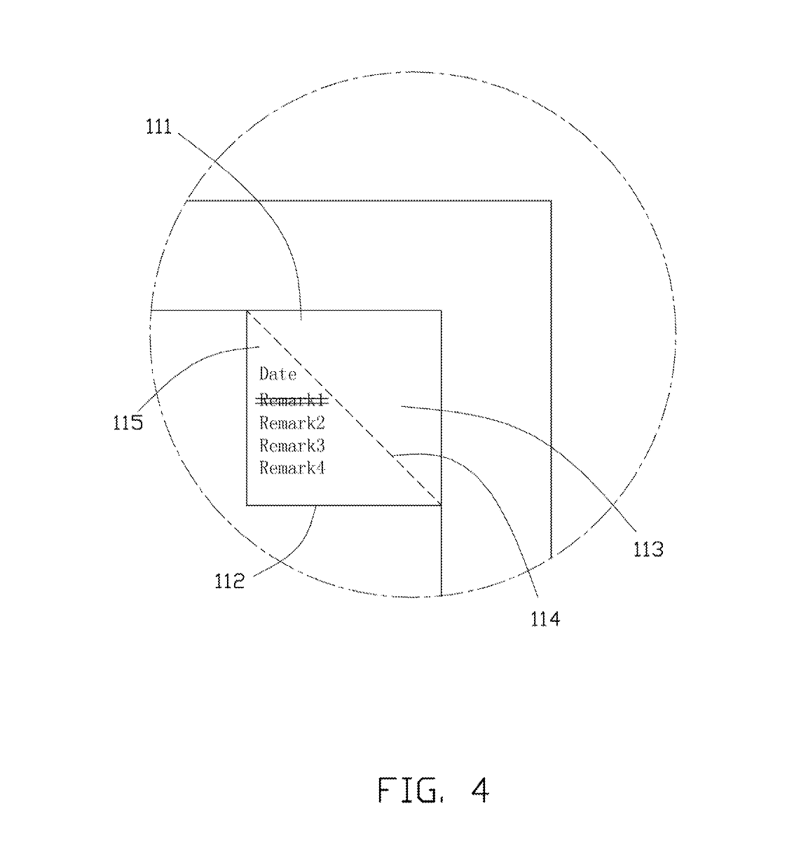

The linking module 103 links the comments of the commend region 115 with the content of the content region in response to a linking operation. FIGS. 3 and 4 show that in the linking operation, the user can draw a certain symbol on the characters of the comment and the content, respectively, such as a double line to select the characters of the commends and the content, via touching the touch screen using his finger or the touch stylus. For example, the user draws two horizontal lines across text “ABC” of the content and “Remark 1” of the comments to link “ABC” of the content and “Remark 1” of the comments, via touching the touch screen using his finger or the touch stylus so that the link can be fast searched when the user selects any one of the “ABC” of the content and “Remark 1” of the comments. The symbols can be other lines such as wave lines, broken, lines, or figures such as a triangle, a circle, for example.

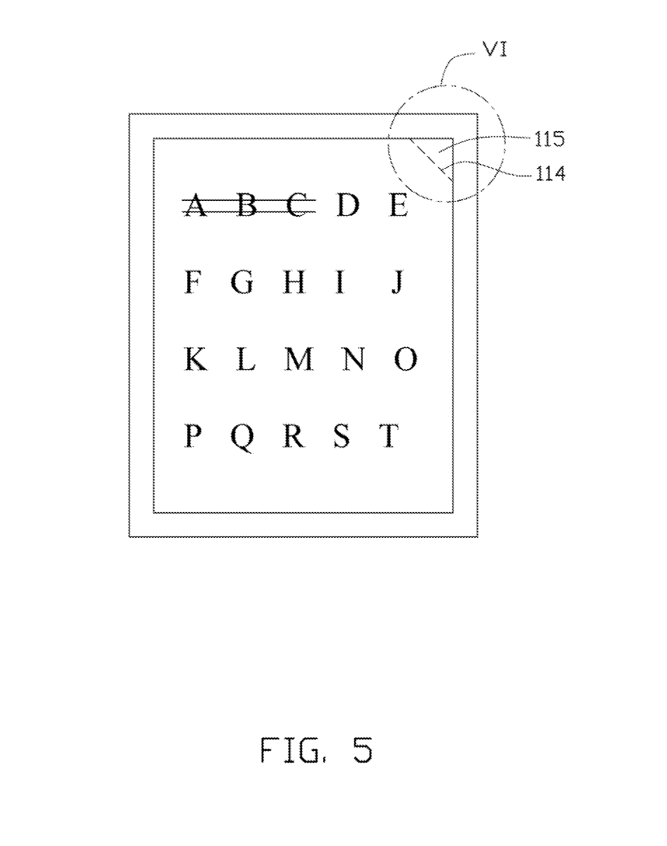

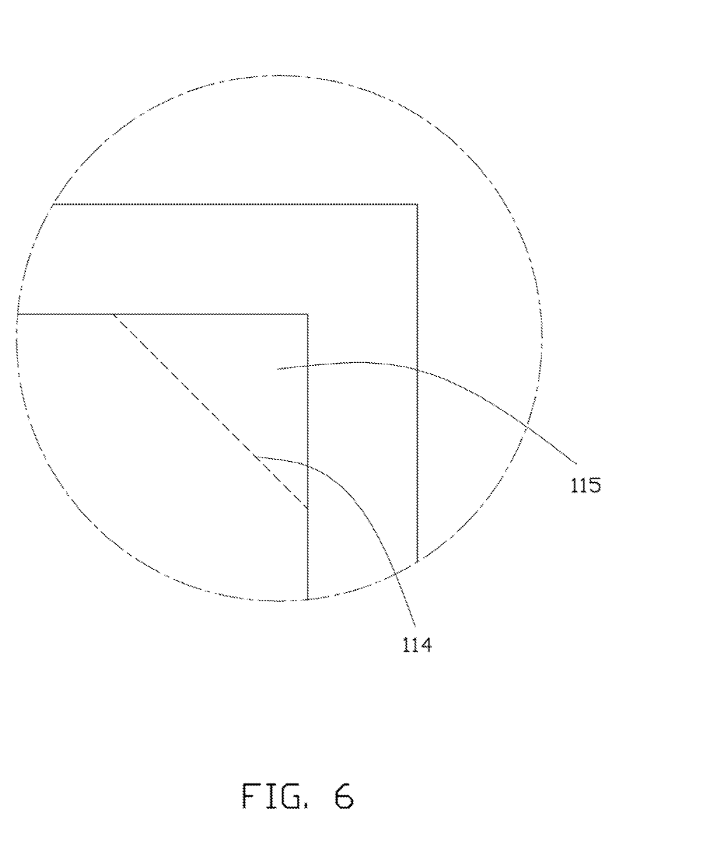

The hiding module 104 hides the comments from view in response to a hiding operation. FIGS. 5 and 6 show that in the hiding operation, the user touches the comment region 115 and slides toward the corner 111 the comment region 115 is folded, via touching the touch screen using his finger or the touch stylus so that the comments are hidden. For convenience of the user to search the comments, the folded line of the corner region 13 (i.e. the diagonal line 114) can be displayed in broken lines. The comment region 115 can be marked in a certain color.

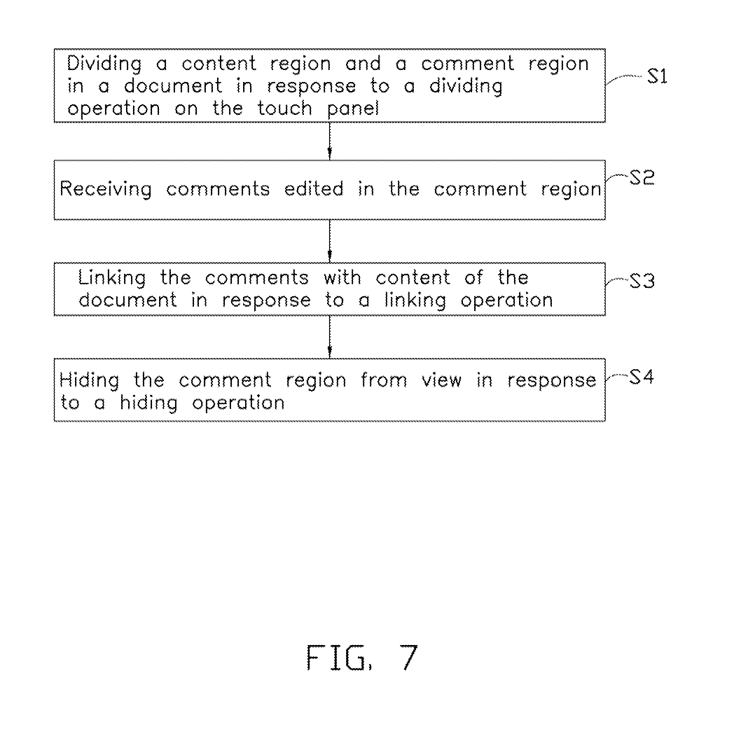

FIG. 7 is a flowchart of one embodiment of a comment inserting method using the comment inserting system 10 of FIG. 1. Depending on the embodiment, additional steps may be added, others removed, and the ordering of the steps may be changed.

In step S1, the dividing module 101 divides a content region and a comment region of an electronic document respectively displaying content and comments of the document in response to a dividing operation performed on the touch panel 11. FIG. 2 shows that the touch panel 11 is substantially rectangular and includes a corner 111 formed by two perpendicularly connected adjacent edges of the touch panel 11. In the dividing operation, a user can draw a substantially L-shaped broken line 112 at the corner 111 by touching the touch screen 11 using his finger or a touch stylus. Two ends of the broken line 112 are perpendicularly connected to the two edges of corner 111 and form a corner region 113 with the corner 111. A region of the touch panel 11 excepting the corner region 113 is defined as the content region. The corner region 13 is folded along a diagonal line 114 of the corner region 113 to form the substantially triangular comment region 115.

In step S2, the receiving module 102 receives the comments edited in the comment region 115 from an editing operation. In the editing operation, the user can performs a double click operation the comment region 115 by touching the touch screen using his finger or the touch stylus and then edits the comments in the comment region 15 by adding or deleting characters of the comments.

In step S3, the linking module 103 links the comments of the commend region 115 with the content of the content region in response to a linking operation. FIGS. 3 and 4 show that in the linking operation, the user can draw a certain symbol on the characters of the comment and the content, respectively, such as a double line to select the characters of the commends and the content, via touching the touch screen using his finger or the touch stylus. For example, the user draws two horizontal lines on “ABC” of the content and “Remark 1” of the comments to link “ABC” of the content and “Remark 1” of the comments, via touching the touch screen using his finger or the touch stylus so that the link can be fast searched when the user select any one of the “ABC” of the content and “Remark 1” of the comments.

In step S4, the hiding module 104 hides the comments from view in response to a hiding operation. FIGS. 5 and 6 show that in the hiding operation, the user folds the comment region 115 by touching and sliding toward the corner 111 so that the comments are hidden, via touching the touch screen using his finger or the touch stylus.

In addition, after step S4, for the convenience of the user to search the comments, the folded line of the corner region 13 (i.e. the diagonal line 114) can be displayed in broken line. The comment region 115 can be marked in a certain color.

In summary, the comment region 115 is positioned on the corner region 13 of the touch panel 11, which is convenient for the user to search the comments. In addition, the user can quickly search the link between the comments and the content when the user selects any one of the content and the comments. The comments can be hidden by the hiding module 104 to effectively avoid the comment region covering the content region.

Although numerous characteristics and advantages of the exemplary embodiments have been set forth in the foregoing description, together with details of the structures and functions of the exemplary embodiments, the disclosure is illustrative only, and changes may be made in detail, especially in the matters of arrangement of parts within the principles of disclosure to the full extent indicated by the broad general meaning of the terms in which the appended claims are expressed.

What is claimed is:

1. A computer-implemented method of an electronic device, the electronic device comprising a touch panel, the touch panel comprising a corner formed by two adjacent edges of the touch panel, the method comprising:
dividing a content region and a comment region of an electronic document in response to a dividing operation performed on the touch panel, the dividing operation implemented by drawing a broken line perpendicularly connecting the two adjacent edges to form an corner region and folding the corner region to form the comment region;
receiving comments edited in the comment region; and
linking the comment with content of the document in response to a linking operation.

2. The method according to claim 1, wherein the comment region is substantially triangular.

3. The method according to claim 1, wherein the linking operation is implemented by drawing a determined symbol across characters of the comments and remaining content.

4. The method according to claim 1, further comprising hiding the comment region in response to a hiding operation performed on the touch panel.

5. The method according to claim 4, wherein the hiding operation is implemented by touching and sliding the comment region toward the corner to fold the comment region.

6. An electronic device, comprising:
a touch panel, the touch panel comprising an corner formed by two adjacent edges;
a storage device;
at least one processor; and
one or more modules that are stored in the storage device and executed by the at least one processor, the one or more modules comprising:
a dividing module that divides a content region and a comment region of an electronic document in response to a dividing operation on the touch panel, the dividing operation implemented by drawing a broken line perpendicularly connecting to the edges to form an corner region and then folding the corner region to form the comment region;
a receiving module that receives comment edited in the commend region; and
a linking module that links the comment with content of the document in response to a linking operation.

7. The electronic device according to claim 6, wherein the comment region is substantially triangular.

8. The electronic device according to claim 8, wherein the link operation is implemented by drawing a certain symbol on the characters of the comment and the content.

9. The electronic device according to claim 7, wherein further comprising a hiding module hides the comment region in response to a hiding operation.

10. The electronic device according to claim 10, wherein the hiding operation is implemented by touching and sliding the comment region toward the corner to fold the comment region.

11. A non-transitory storage medium having stored instructions that, when executed by a processor of an electronic device, causes the electronic device to perform a method for inserting comment, the electronic device comprising a touch panel, the touch panel comprising an corner formed by two adjacent edges, the method comprising:
dividing a content region and a comment region of an electronic document respectively in response to a dividing operation on the touch panel, the dividing operation implemented by drawing a broken line perpendicularly connect to the edges to form an corner region and then folding the corner region to form the comment region;
receiving the comments edited in the commend region; and
linking the comments with content of the document in response to a linking operation.

12. The non-transitory storage medium according to claim 11, wherein the comment region is substantially triangular.

13. The non-transitory storage medium according to claim 11, wherein the linking operation is implemented by drawing a certain symbol on the characters of the comments and the content.

14. The non-transitory storage medium according to claim 11, further comprising hiding the comment region in response to a hiding operation.

15. The non-transitory storage medium according to claim 14, the hiding operation is implemented by touching and sliding the comment region toward the corner to fold the comment region.
